(19) United States
(12) Patent Application Publication
(10) Pub. No.: US 2014/0133026 A1
(43) Pub. Date: May 15, 2014

(54) Three-Dimensional Viewer

(71) Applicant: NOW INNOVATION, INC., North York (CA)

(72) Inventor: Gene Khasminsky, North York (CA)

(73) Assignee: NOW INNOVATION, INC., North York (CA)

(21) Appl. No.: 13/675,088

(22) Filed: Nov. 13, 2012

(51) Int. Cl. G02B 27/22

(52) U.S. Cl. CPC G02B 27/2278
USPC 359/478

(57) ABSTRACT

A viewer to give a 3D effect based on two or more two-dimensional images has an area for inserting and securing a back-lit screen for displaying images, the screen mounted in the housing and facing into the viewing area and divided into two or more screen portions, and has two or more translucent planes, stacked in relation to the viewing aperture, each plane mounted within the viewing area adjacent to a screen portion and angled to project one or more images from the screen portion out through the viewing aperture, wherein images on planes closer to the viewing aperture appear superimposed over images on planes further from the viewing aperture. Another embodiment has one or more translucent planes defining a viewing area, and a back-lit screen for displaying images facing into the viewing area, wherein the one or more planes are angled from the screen.

### FIELD OF THE INVENTION

The invention relates to 3D viewers for electronic devices.

### BACKGROUND OF THE INVENTION

Smartphones and other portable devices with screens have been used for some time to display two-dimensional (2D) images and video to a user. Larger devices having a back-lit such as televisions and computers also project 2D images into the eyes of a user. A significant shortcoming of 2D entertainment is that it pales in experience with our 3D view on the real world. Therefore there have been attempts in the art to produce 3D projected images.

3D televisions have been on the market for some time however require glasses, which block alternating eyes in synchronicity with the television, to show slightly different views to each eye to provide a perception of depth. However, the glasses are cumbersome and uncomfortable to wear, and each set of glasses may be used by only one user at a time.

Therefore there is a need for 3D projection technologies that provide a perception of three dimensions to users without the need for cumbersome glasses and complicated synchronizing systems.

### SUMMARY OF THE INVENTION

Disclosed is a viewer providing a 3D effect comprising a housing containing a viewing area and having a viewing aperture, a back-lit screen for displaying images, the screen mounted in the housing and facing into the viewing area, the screen divided into two or more screen portions, and two or more translucent planes, stacked in relation to the viewing aperture, each plane mounted within the viewing area adjacent to a screen portion and angled to project one or more images from the screen portion out through the viewing aperture, wherein images on planes closer to the viewing aperture appear superimposed over images on planes further from the viewing aperture.

Further disclosed is a viewer providing a 3D effect comprising one or more translucent planes defining a viewing area, and a back-lit screen for displaying images, facing into the viewing area, wherein the one or more planes are angled from the screen to receive an image from the screen.

Further disclosed is a viewer providing a 3D effect comprising a back-lit screen for projecting images, divided into two or more screen portions, and at least two translucent planes, stacked in relation to each other and each positioned adjacent to a screen portion, wherein the screen portions project images on the planes for a 3D effect.

One embodiment further comprises a housing containing a viewing area and having a viewing aperture. In an embodiment the screen is divided into screen portions, wherein each screen portion displays an image for a particular plane. The screen may be removable. In a preferred embodiment the screen is a portable device screen and the portable device is removably mounted within the housing.

The housing may have an opening opposite the viewing aperture to view images on the one or more planes plane superimposed over the environment. Further, the angle and position of the planes may be adjustable. The planes may be molded in the housing and may be transparent.

Further disclosed is a three-dimensional viewer comprising a screen for displaying images, the screen divided into two or more screen portions, and a set of two or more planes and projecting from the screen, wherein each screen portion corresponds to a particular plane and the image from the screen portion is partially reflected in the corresponding plane.

In one embodiment the planes are translucent. The planes may be transparent. The screen may be a portable device screen. The planes may be symmetrical or asymmetrical. Further, a screen controller (not shown) that splits a screen image into at least two images for display on two or more screen portions corresponding to the two or more planes may be used. Preferably, the viewer is used for gaming.

Further objects and advantages of this invention will be apparent from the following detailed description of the presently preferred embodiments which are illustrated schematically in the accompanying drawings.

### BRIEF DESCRIPTION OF THE FIGURES

FIG. 1 is a perspective view of the stacked configuration of the 3D viewer device, according to one embodiment of the present invention;

FIG. 2 is a cut-away perspective view of stacked configuration of the 3D viewer device, according to one embodiment of the present invention;

FIG. 3 is a cut-away elevation view of the stacked configuration of the 3D viewer device, according to one embodiment of the present invention;

FIG. 4 is a perspective view of a pyramidal configuration of the 3D viewer device, according to another embodiment of the present invention;

FIG. 5 is an elevation view of a pyramidal configuration of the 3D viewer device, according to another embodiment of the present invention;

FIG. 6 is an elevation view of the V-configuration of the 3D viewer device, according to one embodiment of the present invention; and

FIG. 7 is a perspective view of the V-configuration of the 3D viewer device, according to one embodiment of the present invention.

FIG. 8 is a flowchart of using the device.

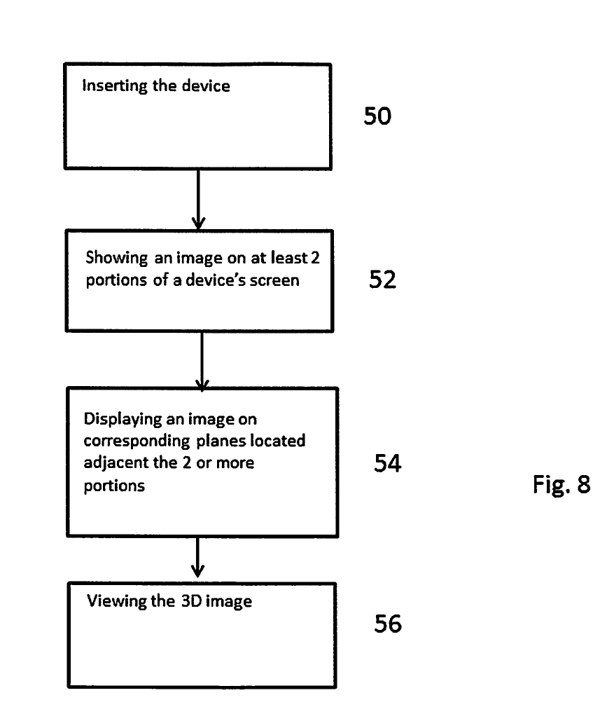

### DETAILED DESCRIPTION OF THE INVENTION

Before explaining the disclosed embodiments of the present invention in detail it is to be understood that the invention is not limited in its applications to the details of the particular arrangements shown since the invention is capable of other embodiments. Also, the terminology used herein is for the purpose of description and not of limitation.

The three-dimensional (3D) viewer is an enclosure that fits around a display system, such as that of a portable smartphone or tablet having a screen, or a non-portable device having a screen, and produces an image that has perceived depth for a user looking in. In one embodiment it produces an image that appears to float in space. The viewer is intended but not limited to use with portable devices such as smart phones, PDA's, tablets and other portable electronics (portable image electronics) that produce a viewable image through a back lit screen. Furthermore, an image producing electronics could by design, incorporate the device as a permanent feature.

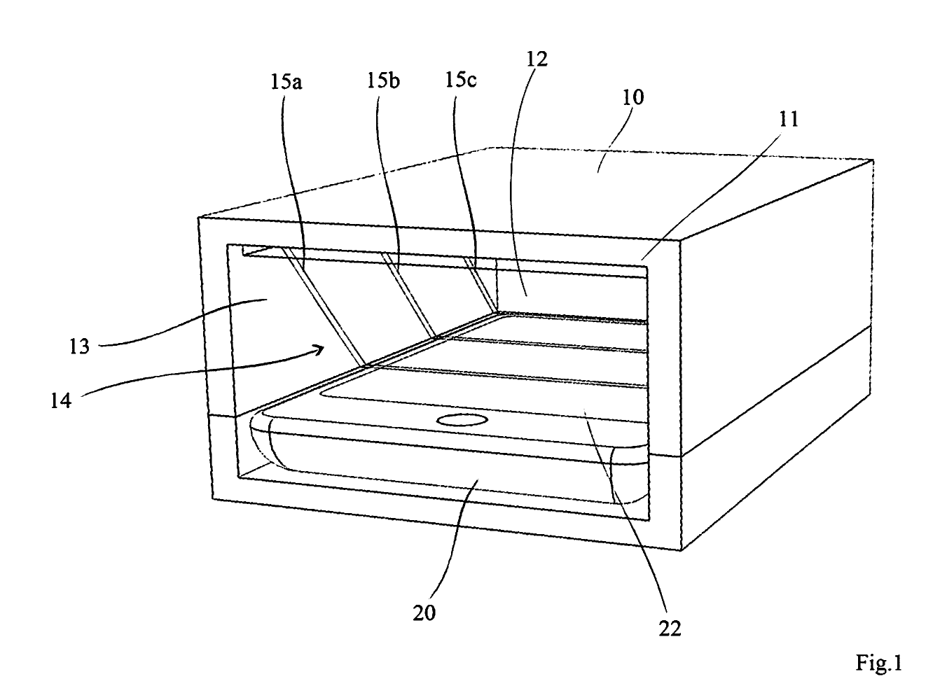

With reference to FIG. 1, a stacked configuration of the viewer is shown. In one embodiment the viewer 2 has a housing 10 that blocks all or most ambient light from entering the viewing area 12, which is enclosed and defined by the housing 10, with the exception of a viewing aperture 14 in the front of the viewer, through which a user looks to view the image. The housing 10 may be any shape, but in particular, when used for gaming, may take the shape of an object a game player interacts with, such as a gun, a motorcycle console, a race car steering wheel and console. The housing 10 is frequently an opaque and robust material such as plastic for blocking light and for protecting the viewing area 12, however in certain applications the housing 10 is partially transparent. The housing does not flex such that it holds the contents of the viewing area 12 in a fixed dimensional relationship. Preferably the viewer is made from plastic, however components such as the housing 10 may be made from a number of other materials, including metal, wood or other materials known in the art, and planes 15 within the housing 10 may be glass. The housing 10 has a ceiling 11 therein and walls 13 at the side and rear, blocking ambient light and preventing viewing out of the viewer. The interior of the housing 10, including ceiling 11 and walls 13, is absorbent of light so as to minimize reflected light, images and other similar interference. In an embodiment, the housing 10 may have an opening opposite the viewing aperture 14 so that the viewer may view through the viewing area and out into the environment, to see an image in the viewing area 12 superimposed over the environment, to provide a 3D effect. In this embodiment there is no rear wall 13 (not shown) to the housing 10.

In an embodiment, the housing 10 is unnecessary and the planes 15 may be positioned on their own over the screen 22, the images viewable by the user on the planes 15 themselves, from practically any angle. Without a housing they may employ a frame to hold the planes 15 in position relative to one another. Without the housing blocking ambient light the image may be difficult to see unless in low-light conditions.

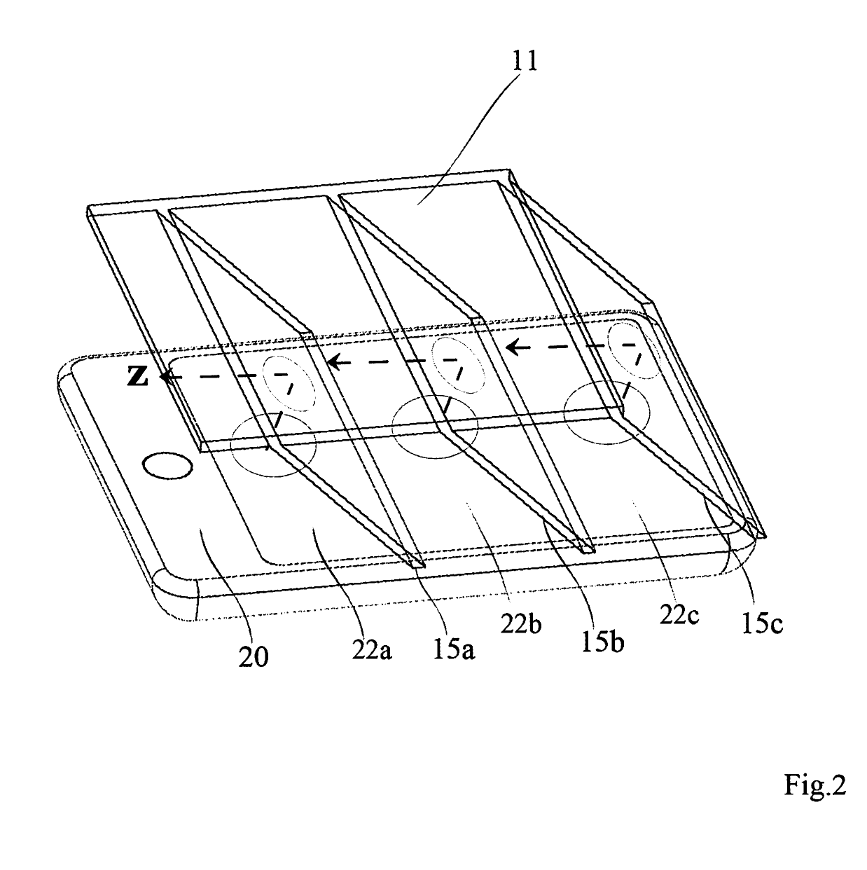

With reference to FIGS. 1 and 2 the housing contains the viewing area having one or more inclined planes 15 (three planes 15a, 15b and 15c in this embodiment) therein, and a device 20 having a back-lit screen 22 facing into the viewing area 12. The housing 10 encloses the inclined planes 15, which in one embodiment are fixed into the walls 13 and ceiling 11 of the housing such that they remain fixed relative to one another and the back-lit screen 22. The screen 22 may be mounted above, below or to the side of the viewing area 12, and the planes 15 are mounted adjacent to the screen 22, so as best to receive the light transmitted from the screen. They may be mounted within grooves cut into the walls 13 and ceiling 11, molded into position or held by means of mounting brackets, the use of which is known in the art.

In another embodiment the planes are movable for angle and position, projecting through the housing and adjustable from the outside or adjustable within once the housing is opened. The planes 15 are in a stacked relationship with one another, that is they are in front of one another with reference to the viewing aperture 14, such that when a user views through the viewing aperture 14, he or she sees through the multitude of planes 15, and images they carry are therefore superimposed over one another. In an embodiment, the planes 15 are user adjustable, and may be constrained in a fixed position relative to each other and the screen 22.

The inclined planes 15 are capable of reflecting light, and may be transparent, translucent, and in one embodiment when a multiplicity of planes are used the plane that is located furthest from the viewing point of the user could be, but does not necessarily have to be, opaque. In a preferred embodiment the planes are translucent. Considering clear glass transmits only about 80% of visible light, clear glass is also considered translucent for the purposes of this disclosure. The screen 22 is divided into screen portions 22a-22c, wherein each screen portion 22a-22c displays an image for a particular plane 15a-15c. The screen 22 may be fixed within the housing or may be removable, and in a preferred embodiment the screen 22 used is that of a portable device such as a smartphone or table computer, which is inserted into the housing 10 and removably secured there. In one embodiment the housing 10 is adjustable for different screen sizes and contains markers to align the particular screen correctly and the screen 22 may be removably secured within the housing 10. In one embodiment a screen controller (not shown) splits a single screen image into at least two images for display on two or more screen portions corresponding to the two or more planes, to provide a 3D effect. The screen controller (not shown) may be implemented in software, firmware or hardware.

The result of the above configuration is that content on the screen of the image electronics are reflected off the inclined planes 15 towards a user or viewer. As the planes 15 are transparent or translucent the viewer is able to see the image on the inclined plane closest to them as well as being able to see images that are reflected off of each subsequent translucent or transparent plane further away from them. Regarding the translucent planes, some light is reflected to the eyes of the user following light path Z, and some light remains on the plane and is visible there, potentially from any angle. Transparent planes reflect the image due to the inclination of the plane and the phase change from air to solid material. Removal of the ambient light greatly increases visibility of the image. Since the planes are translucent, they project a reflection of the screen image 22 to the viewer, however the user can see through each one to superimpose that image with the “layer” behind. The result is a 2D image on each plane that produces a composite image that appears 3D due to layering that is achieved by using translucent or transparent planes, wherein the viewer's eye recognizes that the composite image has depth. Translucent Even a single plane provides an image that appears to be floating in air, within the dark void of the enclosed viewing area 12 or particularly where the viewing area 12 can be seen through to the environment, so that the floating image is superimposed on the environment.

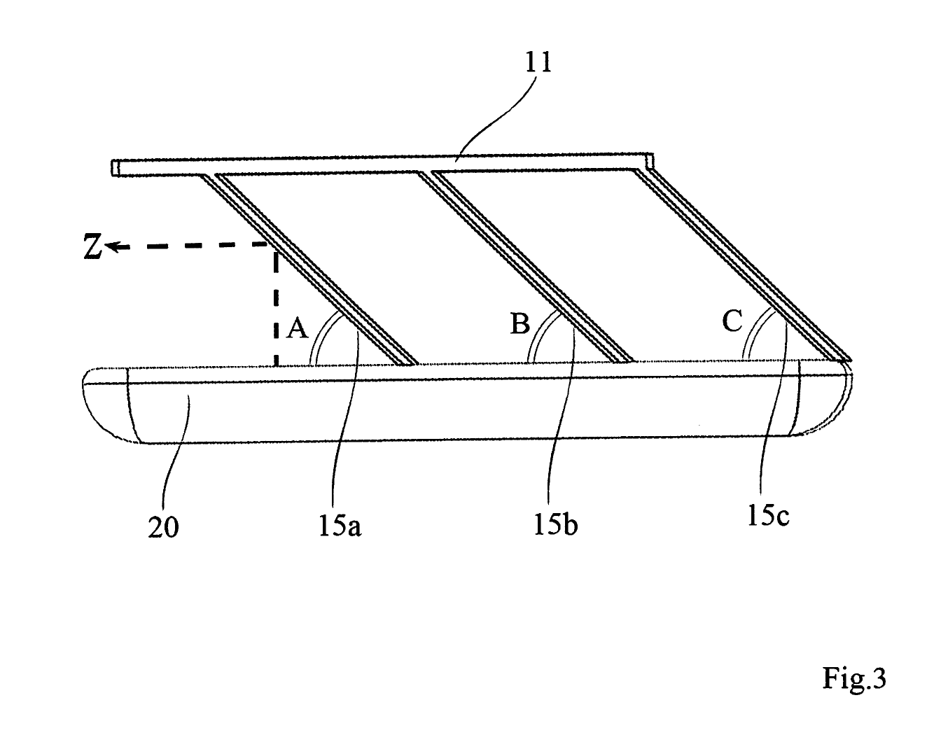

With reference to FIGS. 1 to 3, the inclined planes 15a-c are spaced relative to the screen portions 22a-c and have an angle A, B, C such that they reflect the images from the screen portions out the viewing aperture 14 and into the eyes of a user. The light path from the screen 22a-c to the respective plane 15a-c, and on to the eyes of the user, is shown in stippled lines Z. The angle A, B, C depends on the height of the planes 15a-c and size of each of the screen portions or “slices”, and may be the same between planed 15a-c or may differ for each plane 15a-c depending on the configuration of the viewer. The screen may be divided into a multitude of parts, typically corresponding to the number of planes 15. The plane 15 angle may range from 20 to 80 degrees; however a preferred range is 30-60 degrees, which results in a reasonable number of screen slices and a reasonable height of the viewing aperture 14. In the embodiment shown, the angle is approximately 45 degrees. The number of screen slices is unlimited, only constrained by the thickness of each plane 15 and the length of the screen 22. In multi-plane embodiments every plane angle need not be the same, and each plane may be at a different angle. The more slices, the smaller the screen or the more obtuse the angle needs to be in order to fit the constraints of the screen 22.

For example, in the embodiment shown in FIGS. 1-3, a three-plane viewer would divide the screen 22 into thirds, with an image showing on each third. Each third is, in turn, projected into the eyes of a viewer by means of i) the translucence of the planes, and ii) the angle of the planes oriented to reflect the image out through the aperture 14. Due to the translucence or transparency of each plane 15, the user partially sees through the planes so that the images superimpose on one another, while maintaining their relative depth, to provide the perception of a three-dimensional image. The depth would be limited to one of three depths, wherein the planes 15 appear. The image of plane 15a will be perceived as in front of that of plane 15b, and the image of plane 15c will appear behind that of plane 15b. The viewer has the surprising benefit of producing 3D images having depth that may be viewed with the naked eye, without the need for special glasses. Images may be rapidly sequential so as to produce the perception of movement, in the case of video images for example.

As an example of a use, the housing 10 is in the form of a motorcycle console with handlebars, for playing a motorcycle game. The handlebars have controls, such as throttle and brake that are communicated to a smartphone, as well as movement of the console from side-to-side, which is communicated to the smartphone by means of the smartphone's accelerometer. The smartphone is inserted face-up against the bottom of the inside of the housing 10. The housing 10 is hinged at the back and closed over the smartphone so as to retain the smartphone therein, such that the planes 15 are adjacent to the screen 22. The gamer looks through the viewing aperture 14. The image on plane 15a is closest to the viewer and represents the foreground, so may show a competing rider directly in front of the player's motorcycle. The image on plane 15b represents the midground, so a number of the motorcycles that are farther ahead, as well as signs on the road. The furthest image on plane 15c represents the background, such as the grandstands and the upcoming curves.

In another embodiment, the smartphone is similarly enclosed in the housing, however the housing has an opening opposite the viewing aperture 14 so the gamer may see into the environment, through the planes 15. The housing may be shaped like a gun. Again, the planes show foreground in plane 15a, midground in plane 15b, and background in plane 15c, with the background further supplemented by the environment, like a forest or marsh, that the gamer is physically playing in. The foreground depicts damage when the gamer is hit, or enemies that are very near. The midground shows enemies further away. The background shows far objects in the distance that provide context.

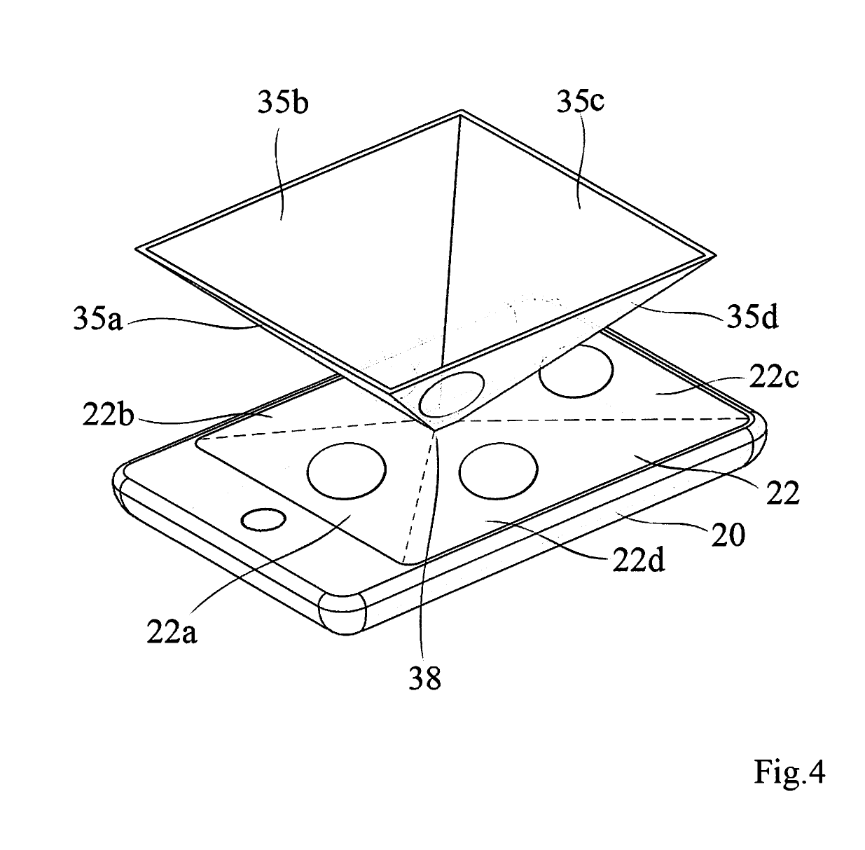

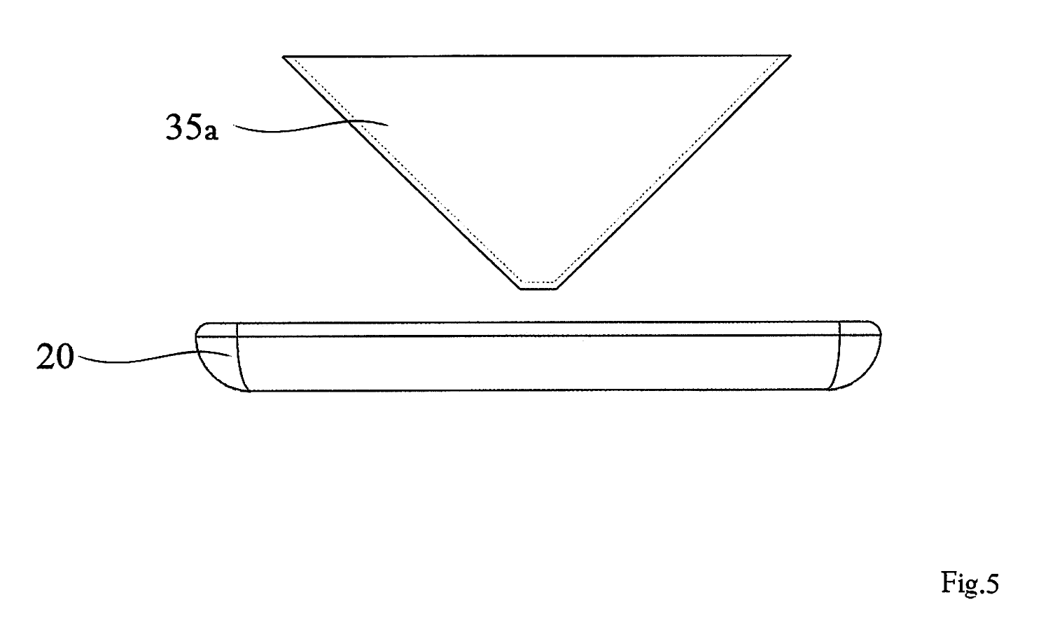

With reference to FIGS. 4 and 5, a pyramidal configuration is shown. This embodiment enables projection of an image that appears to float in space within the viewing area 12 defined by the planes 35a, 35b, 35c, 35d. The viewer is located at a distance relative to the screen of the electronics such that one or more users can view the reflected 3D image from a variety of locations around the viewer. A housing (not shown), if used, is adapted to hold a pyramidal set of planes 35a, 35b, 35c, 35d over the screen, either directly adjacent to the screen or at a small distance, such as a few centimeters or inches, therefrom. In another embodiment, a simple plastic or wire frame (not shown) holds the pyramidal plane set 35 in position above the screen 22. The planes 35 define a viewing area 12. In this embodiment the set of planes 35a, 35b, 35c, 35d forms a square-based inverse truncated pyramid, having four truncated triangular planes 35a, 35b, 35c and 35d, with the flat apex 38 against the screen 22, and wherein the base is absent. The apex 38 may be used for supporting the planes 35a, 35b, 35c, 35d on the screen 22. Each triangular plane 35a, 35b, 35c and 35d displays a triangular portion of the screen 22 directly below it. In other embodiments the pyramid may be triangular-based or have a plurality of planes such as pentagon-based or hexagon-based pyramid would (not shown).

The screen 22 is divided into 4 triangular portions or “slices”, 22a, 22b, 22c, and 22d, each showing an image that is meant to be displayed in the plane 35a, 35b, 35c, 35d, respectively, that is above it. For example, the images may show different sides of a figure so that the figure appears to be 3D, or may show the same image which will appear to hover in space. Accordingly, plane 35a displays or partially reflects screen portion 22a, plane 35b displays screen portion 22b, plane 35c displays screen portion 22c and so on. Based on the translucent character of the plane, the combination of the images is perceived by the user, who may be at almost any angle from the viewer, as floating in the air within the pyramid. A different view may be shown on each plane, to show the front, left side, rear, and right side of an object for example. The illusion of depth is created due of the lack of other features in the viewing area that would provide a frame of reference, the image appears truly like a hologram suspended in air. Although the set of planes 35a, 35b, 35c, 35d need not be centred over the screen 22, it must be aligned above the screen in accordance with the screen slices 22a-d, so as to display the images correctly. The planes 35 a-d may not all be the same size and orientation, and asymmetrical planes will require asymmetrical screen slices 22a-d that correspond with the orientation of the planes 35 a-d. Each screen portion 22 a-22d corresponds to a particular plane and the image from the screen portion is partially reflected in the corresponding plane, for example the image from screen portion 22b is reflected in plane 35b. The viewer produces the surprising result that a 3D image appears to be floating in air, somewhat like a hologram, and this image can be in motion when the screen is showing video images. This embodiment is most useful for hologram-type images or multiplayer games wherein, for example, each player receives information from a plane to control his “player” in the game.

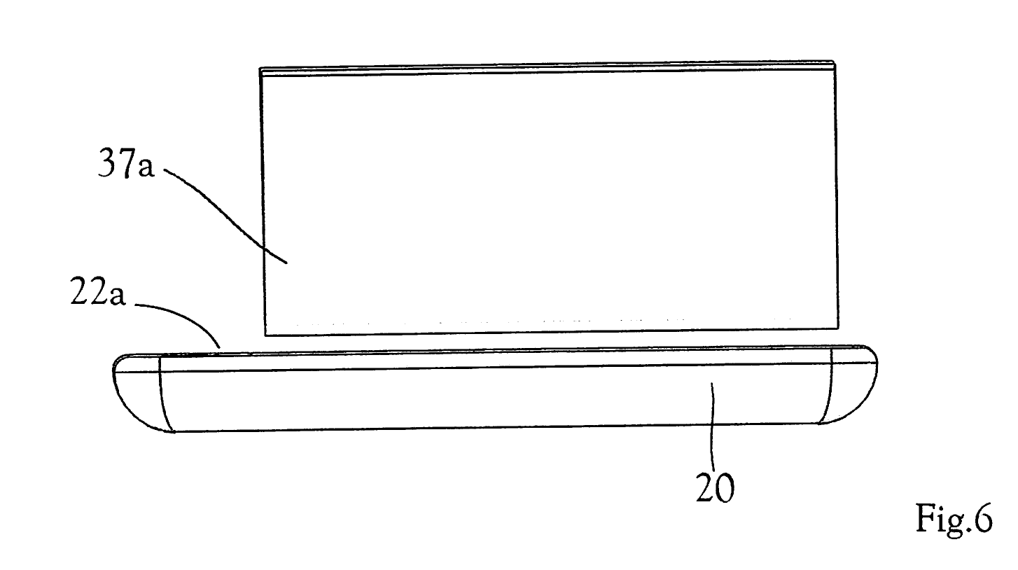

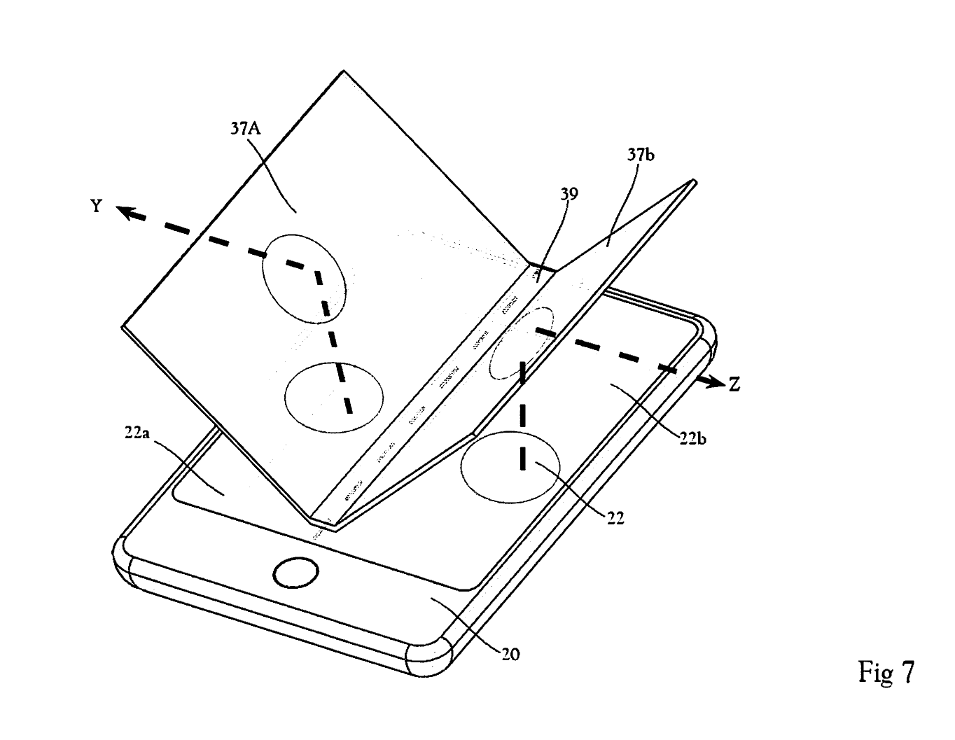

With reference to FIGS. 6 and 7, a V-configuration of the 3D viewer is shown. The two planes 37a and 37b project from the screen 22, which is divided into two screen portions 22a and 22b. Optionally, a flat base 39 helps to hold the planes 37a, 37b on top of the screen 22, wherein planes 37a and 37b are integrally connected to base 39. In other embodiments, a frame (not shown) around the planes 37a and 37b hold the planes in position above the screen 22. The images are projected from the back-lit screen portions 22a, 22b of the device 20, onto the corresponding planes 37a, 37b above, such that images are partially reflected from the translucent plane 37a, 37b following light path Y, Z, and are partially absorbed and emanated from the planes 37a, 37b, such that the images are visible from any angle. As a result, an image appears to float in space, providing the perception of a 3D image. This embodiment is useful for multi-player games, particularly for two players, wherein they sit opposite to one another and each one uses a screen to receive information.

To produce an effective result the viewer is used in conjunction with software on the electronic device that divides the image producing area into segments that are sized proportionate to, and located relative to, each inclined plane such that the image produced in that screen segment is only reflected by the intended plane. When the viewer has multiple planes not all planes or segments of the image producing screen need to be in use at the same time, or at all. When the viewer has multiple parallel planes the image on the screen segment closest to the user will be reflect on the inclined plane 15 closest to the user and hence this image will appear closest to the user. The image produced on each subsequent screen portion 22a, 22b etc. further away from the user will reflect from its appropriate inclined plane 15 and appear at a distance further away from the user. Because the images from the inclined planes 15 located further away from the user are visible through each inclined plane 15 that is closer to the user this creates a depth of image resulting in a 3D effect.

The embodiment of the viewer that is intended to be viewed from multiple viewing angles by multiple users produces a limited depth view because the inclined planes are not parallel to each other. The image reflected from the plane appears to be “floating” in space. A method of using the viewer is disclosed. First, in step 50 the user inserts or positions the portable device within, on, or under the viewer and secures it there. Due to the variety of shapes and sizes of portable image producing electronics the fixture in the viewer that constrains the electronics is adjustable with directions and/or markings to indicate the correct positioning of the most popular electronics. Second, in step 52, showing an image on at least 2 portions of the device's screen. Third, in step 54 displaying the image on corresponding planes located adjacent to the two or more portions. As a fourth step 56, viewing the 3D image.

While the invention has been described, disclosed, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

1. A viewer providing a 3D effect comprising:
a. an area for inserting and securing a back-lit screen for displaying images, the screen mounted in the housing and facing into the viewing area, the screen divided into two or more screen portions; and
b. two or more translucent planes, stacked in relation to the viewing aperture, each plane mounted within the viewing area adjacent to a screen portion and angled to project one or more images from the screen portion out through the viewing aperture;
wherein images on planes closer to the viewing aperture appear superimposed over images on planes further from the viewing aperture, thereby rendering the 3D effect of one or more images.

2. The viewer of claim 1, wherein the screen is divided into screen portions, wherein each screen portion displays an image for a particular plane.

3. The viewer of claim 1 wherein the screen is removable.

4. The viewer of claim 1, wherein the screen is a portable device screen and the portable device is removably mounted within the housing.

5. The viewer of claim 1, wherein the housing further comprises an opening opposite the viewing aperture to view images on the one or more planes plane superimposed over the environment.

6. The viewer of claim 1, wherein angles of the two or more planes are adjustable.

7. The viewer of claim 1, wherein the positions of the two or more planes are adjustable.

8. The viewer of claim 1, wherein the two or more planes are asymmetrical.

9. The viewer of claim 1 further comprising a screen controller that splits a screen image into at least two images for display on two or more screen portions corresponding to the two or more planes.

10. The use of the viewer of claim 1 for gaming.

11. A viewer providing a 3D effect comprising:
a. one or more translucent planes defining a viewing area; and
b. a back-lit screen for displaying images, facing into the viewing area;
wherein the one or more planes are angled from the screen to receive an image from the screen.

12. The viewer of claim 11, wherein angle of the one or more planes is adjustable.

13. The viewer of claim 11 further comprising a housing containing a viewing area and having a viewing aperture.

14. A three-dimensional viewer comprising:
a. a screen for displaying images, the screen divided into two or more screen portions; and
b. a set of two or more planes and projecting from the screen;
wherein each screen portion corresponds to a particular plane and the image from the screen portion is partially reflected in the corresponding plane.

15. The viewer of claim 14 wherein the two or more planes are translucent.

16. The viewer of claim 14 wherein the two or more planes are transparent.

17. The viewer of claim 14 wherein the screen is a portable device screen.

18. The viewer of claim 14 wherein the two or more planes are symmetrical.

19. The viewer of claim 14 wherein the two or more planes are asymmetrical.

20. The viewer of claim 14 further comprising a screen controller that splits a screen image into at least two images for display on two or more screen portions corresponding to the two or more planes.
